(19) United States
(12) Patent Application Publication
(10) Pub. No.: US 2024/0144409 A1
(43) Pub. Date: May 2, 2024

(54) PARENTAL MESSAGING ALERTS

(71) Applicant: Meta Platforms, Inc., Menlo Park, CA (US)

(72) Inventors: Asaf Gelber, New York, NY (US); John Hjelmstad, Seattle, WA (US); Krishna Kumar, San Jose, CA (US)

(73) Assignee: Meta Platforms, Inc., Menlo Park, CA (US)

(21) Appl. No.: 17/978,169

(22) Filed: Oct. 31, 2022

(51) Int. Cl. G06Q 50/26; G06Q 50/00

(52) U.S. Cl. CPC G06Q 50/265; G06Q 50/01

(57) ABSTRACT

Techniques for notifying parent accounts of problematic interactions by teens is described. For example, a social networking system may receive, from a first account of the social networking system, an indication of an interaction between the first account and a content item. Based on determining that the interaction is a problematic interaction, the social networking system may send, to a second account associated with the first account, a notification of the problematic interaction. The social networking system may cause presentation, to the second account, of a selectable control associated with one or more resources regarding addressing the problematic interaction.

### BACKGROUND

Digital platforms by which users can share content provide users with an abundance of freedom and opportunity to connect and communicate with other users across the world. However, this freedom may provide dangers and challenges to some users, particularly those of a young age or those with limited training or exposure to internet safety. To protect users such as these, digital platforms may include supervisory options, such as parental controls, in which parents or guardians may monitor younger users' online activity. However, parental controls are not without problems.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques described herein.

FIGS. 2A and 2B illustrate example interfaces for determining problematic interactions.

FIGS. 3A and 3B illustrate example interfaces for notifying an account of a problematic interaction.

FIG. 4 illustrates an example system and device which may be used to implement the techniques described herein.

### DETAILED DESCRIPTION

As discussed above, controlling how users safely interact in an online environment is not without limitations. In the current digital age, users of all ages and backgrounds have the ability to easily connect and communicate with one another, regardless of geographic location. These advancements have brought significant benefits to society, such as the ability to connect with friends and family, facilitate the spread of ideas, and foster the growth of communities. However, this freedom may also be abused, and has led to issues such as cyber-bullying, harassment, and unwanted interactions, for example. These issues may be particular harmful to users such as teenagers (herein referred to as “teens”), who may have less internet safety training than adults and may be more vulnerable to the negative effects of the internet. Thus, digital platforms often offer “parental controls” in which parents and/or guardians may monitor and/or restrict their child or dependent's internet usage. This may include, for example, limiting screen time, filtering content, and recording conversations. While options such as these may provide insight to a teen's internet activity, these options are often rigid and unyielding, frequently leaving teen users feeling deprived of control. Not only does this foster feelings of distrust between teens and their parents/guardians, but it also often times provides incentive for teens to attempt to hide their internet activity.

This application improves upon current techniques by providing a teen-led experience in which accounts associated with parents/guardians may monitor their teen' activities in online environments, such as social networking systems, while still maintaining a healthy relationship between the parent/guardian and their teen. For example, a “Family Center” may provide an interface by which parents can view the accounts they supervise on social networking systems, manage supervision settings, and access educational resources from experts on building positive and healthy online habits. To associate a parent account to their teen's account, either the teen or their parent may send an invitation to join the Family Center. In allowing teens the option to invite their parents to supervise their accounts, teens are afforded a sense of autonomy over their online presence, creating a healthier relationship between parent and teen.

In some examples, the Family Center may provide equal or similar visibility to teens and parents alike, allowing teens to access the same or similar information that their parents have access to. This information may include metrics associated with the teen's online activity, such as daily screen time and usage information. In some examples, the Family Center may provide one or more resources to parents and teens, such as internet safety training and expert-backed articles and guides.

In some examples, the social networking system may encourage teens to initiate conversations with their parents when they engage in potentially harmful interactions on the social networking system. For example, the social networking system may receive an indication of a problematic interaction between the teen and the social networking system, such as an indication the teen has reported or blocked content. Based on receiving the indication, the social networking system may provide the teen with an option to share this interaction with their parent, providing an opportunity for the teen to initiate a conversation regarding potentially harmful online interactions.

Similarly, the social networking system may autonomically alert the parent to problematic interactions. For example, the social networking system and/or the parent may designate certain interactions as problematic, such as messaging taking place at odd hours in the night. Based at least in part on receiving an indication of this interaction, the social networking system may alert the parent. Thus, parents are made aware of interactions that are likely to be harmful to their child, while still preserving the teen's online autonomy.

These and other aspects are described further below with reference to the accompanying drawings. The drawings are merely example implementations, and should not be construed to limit the scope of the claims. For example, while examples are illustrated in the context of a user interface for a mobile device, the techniques may be implemented using any computing device and the user interface may be adapted to the size, shape, and configuration of the particular computing device.

### Example System

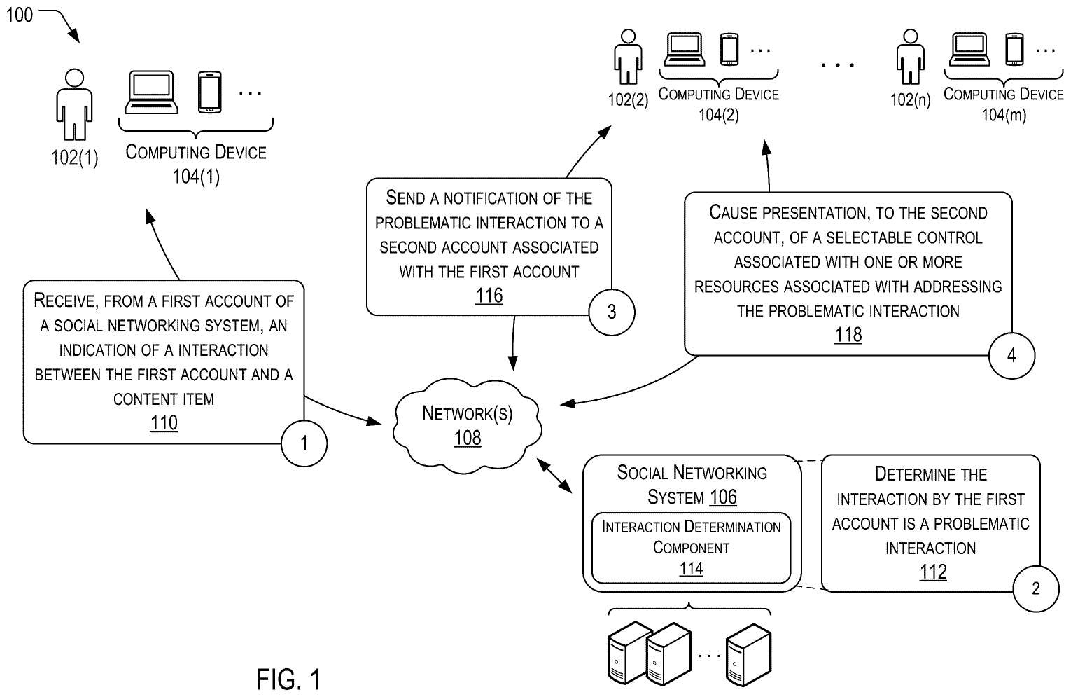

FIG. 1 is a schematic view of an example computing system 100 usable to implement example techniques described herein to alert accounts of a social networking system, such as supervisory accounts (also referred to herein as “parent accounts”) of problematic interactions by other accounts they supervise (herein referred to as “teen accounts”). In some examples, the computing system 100 may include accounts 102(1), 102(2), . . . 102(n) (collectively “accounts 102”) that are associated with users and interact using computing devices 104(1), 104(2), . . . 104(m) (collectively “computing devices 104”) with a social networking system 106 via a network 108. In this example, n and m are non-zero integers greater than 1.

Each of the computing devices 104 includes one or more processors and memory storing computer-executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), wearable devices (e.g., augmented reality or virtual reality devices, glasses, watches, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer-executable instructions to implement the functionality discussed herein attributable to the social networking system 106 or digital platform. The social networking system 106 may enable accounts 102 associated with its users (such as persons or organizations) to interact with the social networking system 106 and with each other via the computing devices 104. The social networking system 106 may, with input from a user, create and store in the social networking system 106 a user account associated with the user. The user account may include demographic information, communication-channel information, financial information and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the accounts 102.

In some examples, the social networking system 106 may be associated with multiple platforms. For example, although the current application is described with respect to a single platform associated with the social networking system 106, the techniques described herein may be applied to any number of platforms associated with the social networking system 106. A second platform, for example, may be administered by the same entity as the first platform or may be administered by separate/unrelated entities. For example, the user may have an account on two platforms offered by the same company, or two separate unrelated platforms offered by separate companies.

For example, at operation 110 (indicated by “1”), the social networking system 106 may receive, from a first account of the social networking system, an indication of an interaction between a first account 102(1) and a content item. Although the current specification describes the first account 102(1) as an account associated with a teen user, any user may be associated with the first account 102(2) regardless of that user's age, education, race, socio-economic status, background, etc.

Content, such as the content item, may take a variety of forms. For example, content may include a profile or feed post, a story, a direct message to one or more other accounts, a reel, a tweet, or a snap, to name a few examples. In general, a profile (or feed) post may include text and/or media content items, such as images, video, and/or audio. The profile post may be published to the social networking system 106 by an account, such as the first account 102(1), for consumption by other accounts 102(2)-102(n), and may be viewable by the other accounts 102(2)-102(n) for as long as the first account 102(1) is active and/or until the post is deleted by the first account 102(1), although examples are considered in which the profile post is removed and/or deleted after an amount of time (e.g., one hour, one day, one week, etc.). In some cases, a profile post shared by the first account 102(1) may be included in respective content feeds of other the accounts 102(2)-102(n) of the social networking system 106 that have “followed” the first account 102(1), are “friends” with the first account 102(1), are connections of the first account 102(1) or are otherwise associated with the first account 102(1).

A story may be similar to a profile post, in that the story may include text and/or media content items, such as images, video, and/or audio, is published to the social networking system 106 by the first account 102(1) for consumption by the other accounts 102(2)-102(n), and may be included in a feed (although, in some cases, a separate feed from the profile post feed). However, a story may differ from a profile post in that the story may be shared only with a selected subset of the first account's 102(1) followers, and/or may be removed from being viewed by followers of the first account 102(1) after a certain period of time (e.g., one hour, one day, one week, etc.). A direct message may also include text and/or media content items, such as images, video, and/or audio, but in general, a direct message is shared with a single other account 102(n) of the social networking system 106, or a selected subset of other accounts 102(2)-102(n) of the social networking system 106 rather than shared with all of an account's 102 followers. Thus, an interaction between the first account 102(1) and content of the social networking system 106 may include a “like,” a “heart,” a “share,” a “comment,” a “save,” a “favorite,” a “report,” or a “block,” to name a few non-limiting examples.

At operation 112 (indicated by “2”), the social networking system 106 may determine the interaction by the first account is a problematic interaction. For example, an interaction determination component 114 of the social networking system 106 may include a machine-learned model, which may be trained to detect a problematic interaction. For example, the interaction determine component 114 may determine that an interaction is more likely to be a negative interaction and result in harm to the first account 102(1), thus making it more likely that a second account 102(2) associated with the first account 102(1), such as a parent, is more likely to want to be aware. For example, a problematic interaction between the first account 102(1) and the social networking system may include at least one of reporting a content item, blocking a content item, hiding a content item, reporting an account 102 (n) of the social networking system; blocking an account 102(n) of the social networking system, or hiding an account 102(n) of the social networking system. In other examples, the problematic interaction may include an interaction with an account 102(n) on the social networking system 106 that the first account 102(1) is not associated with (i.e., an account 102(n) that does not follow the first account 102(1) or that the first account 102(1) does not follow), such as a direct message via the social networking system 106 or a comment on a profile post or story of the first account 102(1). Further, the problematic interaction may be previously defined by the second account 102(1). Other examples of problematic interactions are described in detail, below.

At operation 116 (indicated by a “3”), the social networking system 106 may send, based at least in part on determining that the interaction is a problematic interaction and to the second account 102(2) associated with the first account 102(2), a notification of the problematic interaction. For example, a user associated with the second account 102(2) may be a parent or guardian of the user associated with the first account 102(1). However, these are merely examples, and the second account 102(2), similar to the first account 102(1), may be of any age, education, race, socio-economic status, background, etc. Moreover, while this application describes the first account 102(1) and the second account 102(2) in the context of a parent account and a child account, the techniques described herein may be applied to any user associated with any account, regardless of age, relationship, affiliation, or legal agreement, to name a few non-limiting examples.

In some examples, the notification may be a push notification sent to a computing device 104(2) associated with the second account 102(2). Additionally or alternatively, the notification may be a message sent to an inbox of the second account 102(2), wherein the inbox may be associated with the social networking system 106.

In some examples, the notification may exclude data associated with the interaction. For example, the prompt may include one or more options associated with including and/or excluding information associated with the interaction, wherein information associated with interaction may include data. For example, the problematic interaction may include a direct message between the first account 102(1) and an unrelated third account 102(3). In response to determining the direct message is a problematic interaction, the social networking system 106 may send, to the second account 102(2), an indication that the first account 102(1) has been messaging an unrelated account. However, the notification may, un some examples, exclude data associated with the direct message, such as the content of the direct message and/or an identifier associated with the third account 102(3), for example. Thus, the first account 102(1) is afforded a sense of privacy while still alerting the second account 102(2) of a problematic interaction, fostering a trusting relationship between the first account 102(1) and the second account 102(2).

At operation 118 (indicated by a “4”), the social networking system 106 may cause presentation, to the second account 102(2), of a selectable control associated with one or more resources associated with addressing the problematic interaction. In response to receiving an indication of a selection of the selectable control by the second account 102(2), for example, the social networking system 106 may cause presentation of one or more resources. Resources may include, for example, a “Family Center” which may include articles, videos, blogs, live support, and/or Q&A on topics such as internet safety, discussing internet safety with teens, and/or parenting advice regarding social media, to name a few non-limiting examples.

As described above, problematic interactions may take a variety of forms. For example, the problematic interaction may include a direct message between the first account 102(1) and a third account 102(3), wherein the third account 102(3) has been previously reported on the social networking system 106. For example, the third account 102(3) may have been reported via the social networking system by another account 102 for harassment, bullying, posting inappropriate content, posting hate speech or symbols, posting false information, attempting fraud, or selling illegal or regulated goods, to name a few non-limiting examples. In this way, parents may be made aware of interactions their teens may be having with individuals their teen might not know, or an individual that may pose a risk to their teen.

Additionally or alternatively, a problematic interaction may be an indication of multiple interactions. For example, the social networking system 106 may receive, from a third account 102(3), an indication of a first interaction between the first account 102(1) and the third account 102(3), wherein the third account 102(3) may not be associated with the first account 102(1). The social networking system 106 may then receive, from third account 102(3), an indication of a second interaction between the third account 102(3) and the first account 102(1) prior to receiving a response from the first account 102(1). The social networking system 106 may then determine that the first interaction and the second interaction is a problematic interaction.

In some examples, the social networking system 106 may determine the interaction is a problematic interaction based at least in part on determining that the first account 102(1) is interacting with a third account 102(3) at an “off” time or “downtime,” such as during bedtime or school hours. For example, the social networking system 106 may receive, from the second account 102(2), an indication of a period of time. The period of time may be a time within a day (e.g., between 10:00 AM to 1:00 PM, 9:00 PM to 11:00 PM, etc.) a time across multiple days (e.g., from 10:00 PM Monday to 7:00 AM Tuesday). Additionally or alternatively, the period of time may include a day (e.g., Monday, Tuesday, etc.). In some examples, the period of time may be a default period of time. For example, the period of time may be a time traditionally associated with school hours (e.g., 8:00 AM to 3:00 PM, Monday through Friday).

Based at least in part on receiving the indication of the period of time, the social networking system 106 may determine that the interaction between the first account 102(1) and the content item is within the period of time, thus indication to the social networking system 106 that the interaction is a problematic interaction. In this way, parents may set boundaries on when their teens may be active on the social networking system and be alerted when their teen acts outside these boundaries.

In some examples, the social networking system 106 may determine the interaction is a problematic interaction based at least in part on determining that the first account 102(1) is interacting with an account 102(n) associated with a user that is significantly older than the first account 102(1). For example, the social networking system 106 may determine the interaction is an interaction between the first account 102(1) and the third account 102(3). The social networking system 106 may then determine an age associated with the user associated with the first account 102(1) and an age associated with the user associated with the third account 102(3). In some examples, the social networking system 106 may then determine a difference in age between the age associated with the user associated with the first account 102(1) and the user associated with the third account 102(3). The social networking system 106 may then determine a threshold difference in age and, based at least in part on determining that the difference in age between the age associated with the user associated with the first account 102(1) and the user associated with the third account 102(3) is equal to or greater than the threshold difference in age, the social networking system 106 may determine that the interaction between the first account 102(1) and the third account 102(3) is a problematic interaction. In some examples, the second account 102(2) may determine the threshold difference in age, thus allowing parents to determine the age of other users their teen is interacting with.

In some examples, a parent may wish to allow their teen to interact with certain individuals who are significantly older than their teen, such as family members and close friends. Thus, the social networking system 106 may receive, from the second account 102(1), an indication that a third account 102(3) is an approved account. The social networking system 106 may receive, from the first account 102(1), an indication of an interaction between the first account 102(1) and the third account 102(3) and, based at least in part on receiving the indication that the third account is an approved account, refrain from sending the notification of the interaction between the first account 102(1) and the third account 102(3) to the second account 102(2).

In some examples, the social networking system 106 may provide privacy features to the accounts 102. In particular examples, one or more objects (e.g., content or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular account or other entity to access that object, the object may be described as being “visible” with respect to that account or other entity. As an example, and not by way of limitation, an account of the social networking system 106 may specify privacy settings for a account-profile page that identify a set of accounts that may access work-experience information on the account-profile page, thus excluding other accounts from accessing that information.

In particular examples, privacy settings for an object may specify a “blocked list” and/or a “restricted list” of accounts or other entities that should not be allowed to access certain information associated with the object. In particular examples, the blocked list may include third-party entities. The blocked list or restricted list may specify one or more accounts or entities for which an object is not visible. As an example, and not by way of limitation, an account may specify a set of accounts who may not access photo albums associated with the account, thus excluding those accounts from accessing the photo albums (while also possibly allowing certain accounts not within the specified set of accounts to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by accounts tagged in the photo and friends of the accounts tagged in the photo. In particular examples, privacy settings may allow accounts to opt in to or opt out of having their content, information, or actions stored/logged by the social networking system 106 or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other accounts of the online social network. Similarly, the privacy settings applied to a particular node may control whether the account or concept corresponding to the node is visible to other accounts of the online social network. As an example, and not by way of limitation, the first account 102(1) may share an object to the social networking system 106. The object may be associated with a concept node connected to an account node of the first account 102(1) by an edge. The first account 102(1) may specify privacy settings that apply to a particular edge connecting to the concept node of the object or may specify privacy settings that apply to all edges connecting to the concept node. As another example and not by way of limitation, the first account 102(1) may share a set of objects of a particular object-type (e.g., a set of images). The first account 102(1) may specify privacy settings with respect to all objects associated with the first account 102(1) of that particular object-type as having a particular privacy setting (e.g., specifying that all images posted by the first account 102(1) are visible only to friends of the first account 102(1) and/or accounts tagged in the images).

In particular examples, the social networking system 106 may present a “privacy wizard” (e.g., within a webpage, a module, one or more dialog boxes, or any other suitable interface) to the first account 102(1) to assist the first account 102(1) in specifying one or more privacy settings. The privacy wizard may display instructions, suitable privacy-related information, current privacy settings, one or more input fields for accepting one or more inputs from the first account 102(1) specifying a change or confirmation of privacy settings, or any suitable combination thereof. In particular examples, the social networking system 106 may offer a “dashboard” functionality to the first account 102(1) that may display, to the first account 102(1), current privacy settings of the first account 102(1). The dashboard functionality may be displayed to the first account 102(1) at any appropriate time (e.g., following an input from the first account 102(1) summoning the dashboard functionality, following the occurrence of a particular event or trigger action). The dashboard functionality may allow the first account 102(1) to modify one or more of the first account 102(1)'s current privacy settings at any time, in any suitable manner (e.g., redirecting the first account 102(1) to the privacy wizard).

Privacy settings associated with an object may specify any suitable granularity of permitted access or denial of access, including the “restrict” functionality described herein. As an example and not by way of limitation, access or denial of access may be specified for particular accounts (e.g., only me, my roommates, my boss), accounts within a particular degree-of-separation (e.g., friends, friends-of-friends), account groups (e.g., the gaming club, my family), account networks (e.g., employees of particular employers, students or alumni of particular university), all accounts (“public”), no accounts (“private”), accounts of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers may be authorization/privacy servers for enforcing privacy settings. In response to a request from an account (or other entity) for a particular object stored in a data store, the social networking system 106 may send a request to the data store for the object. The request may identify the account associated with the request and the object may be sent only to the account (or a client system of the account) if the authorization server determines that the account is authorized to access the object based on the privacy settings associated with the object. If the requesting account is not authorized to access the object, the authorization server may prevent the requested object from being retrieved from the data store or may prevent the requested object from being sent to the account. In the search-query context, an object may be provided as a search result only if the querying account is authorized to access the object, e.g., if the privacy settings for the object allow it to be surfaced to, discovered by, or otherwise visible to the querying account. In particular examples, an object may represent content that is visible to an account through a newsfeed of the account. As an example, and not by way of limitation, one or more objects may be visible to a account's “Trending” page. In particular examples, an object may correspond to a particular account. The object may be content associated with the particular account or may be the particular account's account or information stored on the social networking system 106, or other computing system. As an example, and not by way of limitation, a first account 102(1) may view one or more second accounts of an online social network through a “People You May Know” function of the online social network, or by viewing a list of friends of the first account 102(1). As an example, and not by way of limitation, a first account 102(1) may specify that they do not wish to see objects associated with a particular second account in their newsfeed or friends list. If the privacy settings for the object do not allow it to be surfaced to, discovered by, or visible to the account, the object may be excluded from the search results. Although this disclosure describes enforcing privacy settings in a particular manner, this disclosure contemplates enforcing privacy settings in any suitable manner.

In particular examples, different objects of the same type associated with an account may have different privacy settings. Different types of objects associated with an account may have different types of privacy settings. As an example, and not by way of limitation, a first account 102(1) may specify that the first account 102(1)'s status updates are public, but any images shared by the first account 102(1) are visible only to the first account 102(1)'s friends on the online social network. As another example and not by way of limitation, an account may specify different privacy settings for different types of entities, such as individual accounts, friends-of-friends, followers, account groups, or corporate entities. As another example and not by way of limitation, a first account 102(1) may specify a group of accounts that may view videos posted by the first account 102(1), while keeping the videos from being visible to the first account 102(1)'s employer. In particular examples, different privacy settings may be provided for different account & groups or account demographics. As an example, and not by way of limitation, a first account 102(1) may specify that other account who attend the same university as the first account 102(1) may view the first account 102(1)'s pictures, but that other account who are family members of the first account 102(1) may not view those same pictures.

In particular examples, the social networking system 106 may provide one or more default privacy settings for each object of a particular object-type. A privacy setting for an object that is set to a default may be changed by an account associated with that object. As an example, and not by way of limitation, all images posted by a first account 102(1) may have a default privacy setting of being visible only to friends of the first account 102(1) and, for a particular image, the first account 102(1) may change the privacy setting for the image to be visible to friends and friends-of-friends.

In particular examples, privacy settings may allow a first account 102(1) to specify (e.g., by opting out, by not opting in) whether the social networking system 106 may receive, collect, log, or store particular objects or information associated with the account for any purpose. In particular examples, privacy settings may allow the first account 102(1) to specify whether particular applications or processes may access, store, or use particular objects or information associated with the account. The privacy settings may allow the first account 102(1) to opt in or opt out of having objects or information accessed, stored, or used by specific applications or processes. The social networking system 106 may access such information in order to provide a particular function or service to the first account 102(1), without the social networking system 106 having access to that information for any other purposes. Before accessing, storing, or using such objects or information, the social networking system 106 may prompt the account to provide privacy settings specifying which applications or processes, if any, may access, store, or use the object or information prior to allowing any such action. As an example, and not by way of limitation, a first account 102(1) may transmit a message to a second account via an application related to the online social network (e.g., a messaging app), and may specify privacy settings that such messages should not be stored by the social networking system 106.

In particular examples, an account may specify whether particular types of objects or information associated with the first account 102(1) may be accessed, stored, or used by the social networking system 106. As an example, and not by way of limitation, the first account 102(1) may specify that images sent by the first account 102(1) through the social networking system 106 may not be stored by the social networking system 106. As another example and not by way of limitation, a first account 102(1) may specify that messages sent from the first account 102(1) to a particular second account may not be stored by the social networking system 106. As yet another example and not by way of limitation, a first account 102(1) may specify that all objects sent via a particular application may be saved by the social networking system 106.

In particular examples, privacy settings may allow a first account 102(1) to specify whether particular objects or information associated with the first account 102(1) may be accessed from particular client systems or third-party systems. The privacy settings may allow the first account 102(1) to opt in or opt out of having objects or information accessed from a particular device (e.g., the phone book on an account's smart phone), from a particular application (e.g., a messaging app), or from a particular system (e.g., an email server). The social networking system 106 may provide default privacy settings with respect to each device, system, or application, and/or the first account 102(1) may be prompted to specify a particular privacy setting for each context. As an example, and not by way of limitation, the first account 102(1) may utilize a location-services feature of the social networking system 106 to provide recommendations for restaurants or other places in proximity to the account. The first account 102(1)'s default privacy settings may specify that the social networking system 106 may use location information provided from a client device of the first account 102(1) to provide the location-based services, but that the social networking system 106 may not store the location information of the first account 102(1) or provide it to any third-party system. The first account 102(1) may then update the privacy settings to allow location information to be used by a third-party image-sharing application in order to geo-tag photos.

Privacy Settings for Mood, Emotion, or Sentiment Information

In particular examples, privacy settings may allow an account to specify whether current, past, or projected mood, emotion, or sentiment information associated with the account may be determined, and whether particular applications or processes may access, store, or use such information. The privacy settings may allow accounts to opt in or opt out of having mood, emotion, or sentiment information accessed, stored, or used by specific applications or processes. The social networking system 106 may predict or determine a mood, emotion, or sentiment associated with an account based on, for example, inputs provided by the account and interactions with particular objects, such as pages or content viewed by the account, posts or other content uploaded by the account, and interactions with other content of the online social network. In particular examples, the social networking system 106 may use an account's previous activities and calculated moods, emotions, or sentiments to determine a present mood, emotion, or sentiment. An account who wishes to enable this functionality may indicate in their privacy settings that they opt into the social networking system 106 receiving the inputs necessary to determine the mood, emotion, or sentiment. As an example, and not by way of limitation, the social networking system 106 may determine that a default privacy setting is to not receive any information necessary for determining mood, emotion, or sentiment until there is an express indication from an account that the social networking system 106 may do so. By contrast, if an account does not opt in to the social networking system 106 receiving these inputs (or affirmatively opts out of the social networking system 106 receiving these inputs), the social networking system 106 may be prevented from receiving, collecting, logging, or storing these inputs or any information associated with these inputs. In particular examples, the social networking system 106 may use the predicted mood, emotion, or sentiment to provide recommendations or advertisements to the account. In particular examples, if an account desires to make use of this function for specific purposes or applications, additional privacy settings may be specified by the account to opt in to using the mood, emotion, or sentiment information for the specific purposes or applications. As an example, and not by way of limitation, the social networking system 106 may use the account's mood, emotion, or sentiment to provide newsfeed items, pages, friends, or advertisements to an account. The account may specify in their privacy settings that the social networking system 106 may determine the account's mood, emotion, or sentiment. The account may then be asked to provide additional privacy settings to indicate the purposes for which the account's mood, emotion, or sentiment may be used. The account may indicate that the social networking system 106 may use his or her mood, emotion, or sentiment to provide newsfeed content and recommend pages, but not for recommending friends or advertisements. The social networking system 106 may then only provide newsfeed content or pages based on account mood, emotion, or sentiment, and may not use that information for any other purpose, even if not expressly prohibited by the privacy settings.

Privacy Settings for Ephemeral Sharing

In particular examples, privacy settings may allow an account to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, an account may specify that a particular image uploaded by the account is visible to the account's friends for the next week, after which time the image may no longer be accessible to other accounts. As another example and not by way of limitation, a company may post content related to a product release ahead of the official launch and specify that the content may not be visible to other accounts until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of an account associated with the objects or information, and may subsequently delete the objects or information, as specified by the respective privacy settings. As an example, and not by way of limitation, a first account 102(1) may transmit a message to a second account, and the social networking system 106 may temporarily store the message in a data store until the second account has viewed or downloaded the message, at which point the social networking system 106 may delete the message from the data store. As another example and not by way of limitation, continuing with the prior example, the message may be stored for a specified period of time (e.g., 2 weeks), after which point the social networking system 106 may delete the message from the data store.

Privacy Settings for Account-Authentication and Experience-Personalization Information

In particular examples, the social networking system 106 may have functionalities that may use, as inputs, personal or biometric information of a user associated with an account for user-authentication or experience-personalization purposes. An account may opt to make use of these functionalities to enhance their experience on the online social network. As an example, and not by way of limitation, an account may provide personal or biometric information to the social networking system 106. The account's privacy settings may specify that such information may be used only for particular processes, such as authentication, and further specify that such information may not be shared with any third-party system or used for other processes or applications associated with the social networking system 106. As another example and not by way of limitation, the social networking system 106 may provide a functionality for an account to provide voice-print recordings to the online social network. As an example, and not by way of limitation, if an account wishes to utilize this function of the online social network, the user associated with the account may provide a voice recording of his or her own voice to provide a status update on the online social network. The recording of the voice-input may be compared to a voice print of the user associated with the account to determine what words were spoken by the account. The account's privacy setting may specify that such voice recording may be used only for voice-input purposes (e.g., to authenticate the account, to send voice messages, to improve voice recognition in order to use voice-operated features of the online social network), and further specify that such voice recording may not be shared with any third-party system or used by other processes or applications associated with the social networking system 106. As another example and not by way of limitation, the social networking system 106 may provide a functionality for an account to provide a reference image (e.g., a facial profile, a retinal scan) to the online social network. The online social network may compare the reference image against a later-received image input (e.g., to authenticate the account, to tag the account in photos). The account's privacy setting may specify that such voice recording may be used only for a limited purpose (e.g., authentication, tagging the account in photos), and further specify that such voice recording may not be shared with any third-party system or used by other processes or applications associated with the social networking system 106.

Account-Initiated Changes to Privacy Settings

In particular examples, changes to privacy settings may take effect retroactively, affecting the visibility of objects and content shared prior to the change. As an example, and not by way of limitation, a first account 102(1) may share a first image and specify that the first image is to be public to all other accounts. At a later time, the first account 102(1) may specify that any images shared by the first account 102(1) should be made visible only to a group associated with the first account 102(1). The social networking system 106 may determine that this privacy setting also applies to the first image and make the first image visible only to the first account's 102(1) group. In particular examples, the change in privacy settings may take effect only going forward. Continuing the example above, if the first account 102(1) changes privacy settings and then shares a second image, the second image may be visible only to the first account's 102(1) group, but the first image may remain visible to all accounts. In particular examples, in response to an account action to change a privacy setting, the social networking system 106 may further prompt the account to indicate whether the account wants to apply the changes to the privacy setting retroactively. In particular examples, an account change to privacy settings may be a one-off change specific to one object. In particular examples, an account change to privacy may be a global change for all objects associated with the account.

In particular examples, the social networking system 106 may determine that a first account 102(1) may want to change one or more privacy settings in response to a trigger action associated with the first account 102(1). The trigger action may be any suitable action on the online social network. As an example, and not by way of limitation, a trigger action may be a change in the relationship between a first and second account of the online social network (e.g., “un-friending” an account, changing the relationship status between the accounts). In particular examples, upon determining that a trigger action has occurred, the social networking system 106 may prompt the first account 102(1) to change the privacy settings regarding the visibility of objects associated with the first account 102(1). The prompt may redirect the first account 102(1) to a workflow process for editing privacy settings with respect to one or more entities associated with the trigger action. The privacy settings associated with the first account 102(1) may be changed only in response to an explicit input from the first account 102(1) and may not be changed without the approval of the first account 102(1). As an example and not by way of limitation, the workflow process may include providing the first account 102(1) with the current privacy settings with respect to the second account or to a group of accounts (e.g., un-tagging the first account 102(1) or second account from particular objects, changing the visibility of particular objects with respect to the second account or group of accounts), and receiving an indication from the first account 102(1) to change the privacy settings based on any of the methods described herein, or to keep the existing privacy settings.

In particular examples, an account may need to provide verification of a privacy setting before allowing the account to perform particular actions on the online social network, or to provide verification before changing a particular privacy setting. When performing particular actions or changing a particular privacy setting, a prompt may be presented to the account to remind the account of his or her current privacy settings and to ask the account to verify the privacy settings with respect to the particular action. Furthermore, an account may need to provide confirmation, double-confirmation, authentication, or other suitable types of verification before proceeding with the particular action, and the action may not be complete until such verification is provided. As an example, and not by way of limitation, an account's default privacy settings may indicate that a person's relationship status is visible to all accounts (i.e., “public”). However, if the account changes his or her relationship status, the social networking system 106 may determine that such action may be sensitive and may prompt the account to confirm that his or her relationship status should remain public before proceeding. As another example and not by way of limitation, an account's privacy settings may specify that the account's posts are visible only to friends of the account. However, if the account changes the privacy setting for his or her posts to being public, the social networking system 106 may prompt the accounts with a reminder of the account's current privacy settings of posts being visible only to friends, and a warning that this change will make all of the account's past posts visible to the public. The account may then be required to provide a second verification, input authentication credentials, or provide other types of verification before proceeding with the change in privacy settings. In particular examples, an account may need to provide verification of a privacy setting on a periodic basis. A prompt or reminder may be periodically sent to the account based either on time elapsed or a number of account actions. As an example, and not by way of limitation, the social networking system 106 may send a reminder to the account to confirm his or her privacy settings every six months or after every ten photo posts. In particular examples, privacy settings may also allow accounts to control access to the objects or information on a per-request basis. As an example, and not by way of limitation, the social networking system 106 may notify the account whenever a third-party system attempts to access information associated with the account and require the account to provide verification that access should be allowed before proceeding.

### Example User Interfaces

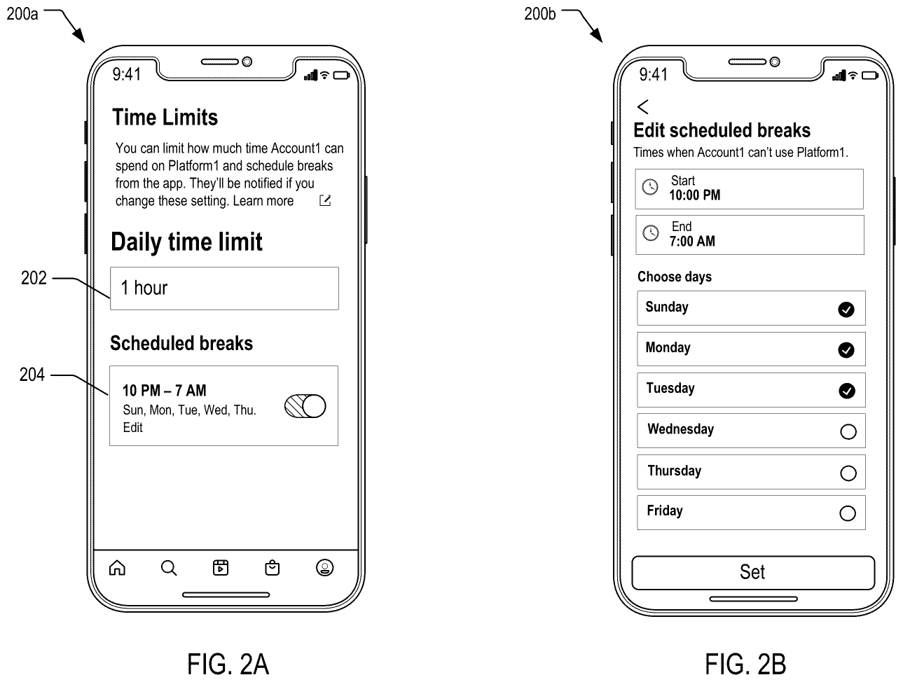

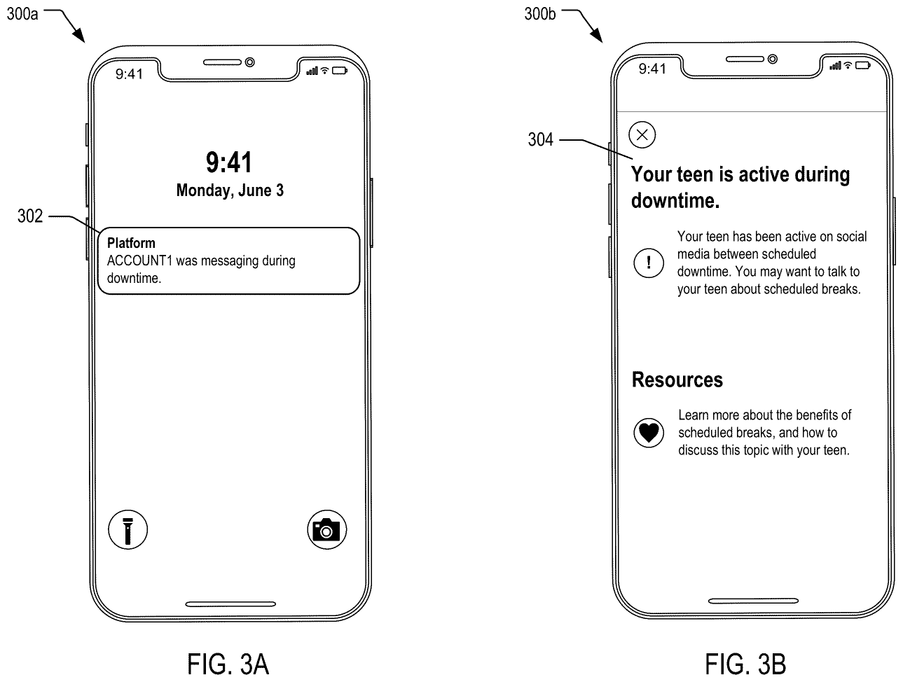

FIG. 2A-FIG. 3B are schematic views showing example user interfaces that are usable to implement the techniques described herein for notifying accounts of problematic interactions by accounts they supervise. The interfaces and/or the notifications may be generated by a computing device of a social networking system (e.g., social networking system 106) and transmitted to one or more user computing devices (e.g., computing devices 104) for presentation, and/or the interfaces may be generated by the one or more user computing devices based at least in part on instructions received from the social networking system 106. As discussed above, the interfaces described in this section may, but need not, be implemented in the context of the computing system 100.

FIGS. 2A and 2B illustrate example interfaces for receiving, from an account of a social networking system, such as the second account 102(2), an indication of a problematic interaction. For example, FIG. 2A illustrates user interface 200a depicting an interface in a “Family Center” in which the second account 102(2) may determine time limits for the first account 102(1) on the social networking system 106. For example, the user interface 200a may include a selectable control 202 associated with a daily time limit. In some examples, the social networking system 106 may receive, from the second account 102(2), an indication of a time limit associated with an amount of time that the first account 102(1) can spend interacting with the social networking system (e.g., 1 hour, 2 hours, 3 hours, etc.). The social networking system 106 may then determine that an interaction by the first account 102(1) with content on the social networking system 106 after the daily time limit is a problematic interaction, thus causing a notification to be sent to the second account 102(2).

In some examples, the user interface 200a may include one or more controls associated with one or more options for the first account 102(1) and/or the second account 102(2) to determine scheduled breaks for the first account 102(1). Similar to the daily time limit, a scheduled break may be a period of time such that an interaction between the first account 102(1) and a content item in that period of time may be determined by the social networking system 106 to be a problematic interaction. In some examples, the scheduled break may be determined by the first account 102(1) and/or the second account. For example, in response to receiving an indication of a selection of the selectable control 204 by the first account 102(1) or the second account 102(2), the social networking system 106 may present, to the first account 102(1) and/or the second account 102(2), user interface 200b, illustrated in FIG. 2B.

For example, user interface 200b may contain one or more selectable controls associated with determining scheduled breaks. In some examples, the social networking system 106 may provide one or more options to customize scheduled breaks, such as by time and day. In this way, parents are provided the ability to help their teens manage their time responsibly on social networking systems.

FIGS. 3A and 3B illustrate example user interfaces for sending a notification of a problematic interaction by a first account, such as the first account 102(1), to a second account, such as second account 102(2). For example, the social networking system may receive, from the first account 102(1), an indication of an interaction between the first account 102(1) and a content item. Based at least in part on determining that the interaction is a problematic interaction, the social networking system 106 may send, to the second account 102(1), an indication of the problematic interaction, such as notification 302. The notification may be, in some a push notification sent to a computing device 104(2) associated with the second account 102(2), as illustrated in user interface 300a. Additionally or alternatively, the notification may be a message sent to an inbox of the second account 102(2), wherein the inbox may be associated with the social networking system 106.

In some examples, the social networking system 106 may provide one or more resources to the second account 102(2) regarding the problematic interaction. For example, user interface 300b, illustrated in FIG. 3B, illustrates another example notification 304 presented to the second account 102(2) by the social networking system. In some examples, the notification 304 may include one or more resources regarding internet safety, such as articles and videos on how to best discuss internet safety with a teen.

### Example System and Device

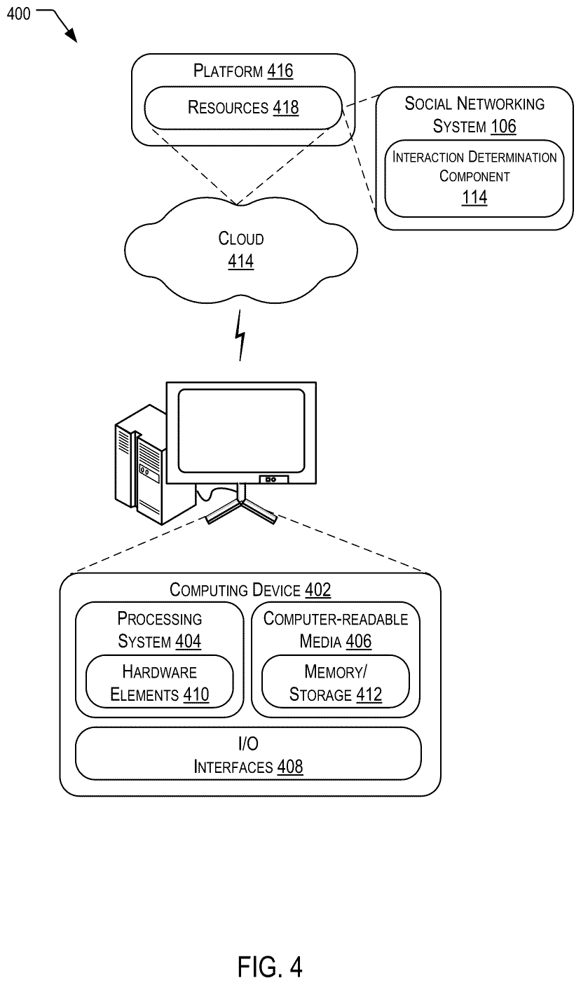

FIG. 4 illustrates an example system generally at 400 that includes an example computing device 402 that is representative of one or more computing systems and/or devices that may implement the various techniques described herein. The computing device 402 may be, for example, a server of a service provider, a device associated with a client (e.g., a client device), an on-chip system, and/or any other suitable computing device or computing system.

The example computing device 402 as illustrated includes a processing system 404, one or more computer-readable media 406, and one or more I/O interface 408 that are communicatively coupled, one to another. Although not shown, the computing device 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware elements 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 406 is illustrated as including memory/storage component 412. The memory/storage component 412 represents memory/storage capacity associated with one or more computer-readable media. The memory/storage component 412 may include volatile media (such as random access memory (RAM)) and/or nonvolatile media (such as read only memory (ROM), Flash memory, optical disks, magnetic disks, and so forth). The memory/storage component 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Input/output interface(s) 408 are representative of functionality to allow a user to enter commands and information to computing device 402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 402. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 402, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 410 and computer-readable media 406 are representative of modules, programmable device logic and/or device logic implemented in a hardware form that may be employed in some examples to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 410. The computing device 402 may be configured to implement particular instructions and/or functions corresponding to the software and/or hardware modules. Accordingly, implementation of a module that is executable by the computing device 402 as software may be achieved at least partially in hardware, e.g., through use of computer-readable storage media and/or hardware elements 410 of the processing system 404. The instructions and/or functions may be executable/operable by one or more articles of manufacture (for example, one or more computing devices 402 and/or processing systems 404) to implement techniques, modules, and examples described herein.

The techniques described herein may be supported by various configurations of the computing device 402 and are not limited to the specific examples of the techniques described herein. This functionality may also be implemented all or in part through use of a distributed system, such as over a “cloud” 414 via a platform 416 as described below.

The cloud 414 includes and/or is representative of a platform 416 for resources 418. The platform 416 abstracts underlying functionality of hardware (e.g., servers) and software resources of the cloud 414. The resources 418 may include applications and/or data that can be utilized while computer processing is executed on servers that are remote from the computing device 402. Resources 418 can also include services provided over the Internet and/or through a subscriber network, such as a cellular or Wi-Fi network.

The platform 416 may abstract resources and functions to connect the computing device 402 with other computing devices. The platform 416 may also be scalable to provide a corresponding level of scale to encountered demand for the resources 418 that are implemented via the platform 416. Accordingly, in an interconnected device embodiment, implementation of functionality described herein may be distributed throughout multiple devices of the system 400. For example, the functionality may be implemented in part on the computing device 402 as well as via the platform 416 which may represent a cloud computing environment or “cloud” 414.

The example systems and methods of the present disclosure overcome various deficiencies of known prior art devices. Other examples of the present disclosure will be apparent to those skilled in the art from consideration of the specification and practice of the disclosure contained herein. It is intended that the specification and examples be considered as example only, with a true scope and spirit of the present disclosure being indicated by the following clauses and claims.

### Example Clauses

Clause 1. A method comprising: receiving, from a first account of a social networking system, an indication of an interaction between the first account and a content item; determining the interaction by the first account is a problematic interaction; sending, based at least in part in determining the interaction is a problematic interaction and to a second account associated with the first account, a notification of the problematic interaction; and causing presentation, to the second account, of a selectable control associated with one or more resources associated with addressing the problematic interaction with the first account.

Clause 2. The method of Clause 1, wherein the problematic interaction is an interaction previously defined by the second account via the social networking system.

Clause 3. The method of Clause 1 or 2, wherein the problematic interaction includes at least one of: a direct message between the first account and a third account of the social networking system, wherein the first account is not associated with the third account; or a direct message between the first account and the third account, wherein the third account has been previously reported on the social networking system.

Clause 4. The method of any of Clauses 1-3, wherein determining the interaction is a problematic interaction further comprises: receiving, from the second account and via the social networking system, an indication of a period of time; and determining the interaction between the first account and the content item is within the period of time.

Clause 5. The method of any of Clauses 1-4, wherein determining the interaction is a problematic interaction further comprises: determining an age associated with a user associated with the first account and user associated with a third account associated with the content item; determining a difference in the age of the user associated with the first account and the user associated with the third account; and determining a threshold age difference; wherein determining that the interaction is a problematic interaction is based at least in part on determining the difference in the age is greater than or equal to the threshold difference in age.

Clause 6. The method of Clause 5, further comprising: receiving, from the second account, an indication that a third account associated with the first account and the second account is an approved account, wherein the age of the user associated with the third account is greater than or equal to the threshold age difference; receiving, from the first account, an indication of an interaction between the first account and the third account; and refraining from sending a notification of the interaction between the first account and the third account to the second account.

Clause 7. The method of any of Clauses 1-6, wherein the one or more resources include one or more suggestions on how to discuss internet safety with a teenager.

Clause 8. The method of any of Clauses 1-7, wherein the second account is a supervisory account of the first account.

Clause 9. A system comprising: one or more processors; and computer-readable media storing instructions that, when executed by the one or more processors, cause the system to perform operations comprising: receiving, from a first account of a social networking system, an indication of an interaction between the first account and a content item; determining the interaction by the first account is a problematic interaction; sending, based at least in part in determining the interaction is a problematic interaction and to a second account associated with the first account, a notification of the problematic interaction; and causing presentation, to the second account, of a selectable control associated with one or more resources associated with addressing the problematic interaction with the first account.

Clause 10. The system of Clause 9, wherein the problematic interaction is an interaction previously defined by the second account via the social networking system.

Clause 11. The system of Clause 9 or 10, wherein the problematic interaction includes at least one of: a direct message between the first account and a third account of the social networking system, wherein the first account is not associated with the third account; or a direct message between the first account and the third account, wherein the third account has been previously reported on the social networking system.

Clause 12. The system of any of Clauses 9-11, wherein determining the interaction is a problematic interaction further comprises: receiving, from the second account and via the social networking system, an indication of a period of time; and determining the interaction between the first account and the content item is within the period of time.

Clause 13. The system of any of Clauses 9-12, wherein determining the interaction is a problematic interaction further comprises: determining an age associated with a user associated with the first account and user associated with a third account associated with the content item; determining a difference in the age of the user associated with the first account and the user associated with the third account; and determining a threshold age difference; wherein determining that the interaction is a problematic interaction is based at least in part on determining the difference in the age is greater than or equal to the threshold difference in age.

Clause 14. The system of Clause 13, further comprising:
receiving, from the second account, an indication that a third account associated with the first account and the second account is an approved account, wherein the age of the user associated with the third account is greater than or equal to the threshold age difference; receiving, from the first account, an indication of an interaction between the first account and the third account; and refraining from sending a notification of the interaction between the first account and the third account to the second account.

Clause 15. One or more non-transitory computer-readable media storing instructions that, when executed by one or more processors of a server computing device, cause the server computing device to perform operations comprising: receiving, from a first account of a social networking system, an indication of an interaction between the first account and a content item; determining the interaction by the first account is a problematic interaction; sending, based at least in part in determining the interaction is a problematic interaction and to a second account associated with the first account, a notification of the problematic interaction; and causing presentation, to the second account, of a selectable control associated with one or more resources associated with addressing the problematic interaction with the first account.

Clause 16. The one or more non-transitory computer-readable media of Clause 15, wherein the one or more resources include one or more suggestions on how to discuss internet safety with a teenager.

Clause 17. The one or more non-transitory computer-readable media of Clause 15 or 16, wherein the second account is a supervisory account of the first account.

Clause 18. The one or more non-transitory computer-readable media of any of Clauses 15-17, wherein the problematic interaction is an interaction previously defined by the second account via the social networking system.

Clause 19. The one or more non-transitory computer-readable media of any of Clauses 15-18, wherein the problematic interaction includes at least one of: a direct message between the first account and a third account of the social networking system, wherein the first account is not associated with the third account; or a direct message between the first account and the third account, wherein the third account has been previously reported on the social networking system.

Clause 20. The one or more non-transitory computer-readable media of any of Clauses 15-19, wherein determining the interaction is a problematic interaction further comprises: receiving, from the second account and via the social networking system, an indication of a period of time; and determining the interaction between the first account and the content item is within the period of time.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first account of a social networking system, an indication of an interaction between the first account and a content item;
determining the interaction by the first account is a problematic interaction;
sending, based at least in part in determining the interaction is a problematic interaction and to a second account associated with the first account, a notification of the problematic interaction; and
causing presentation, to the second account, of a selectable control associated with one or more resources associated with addressing the problematic interaction with the first account.

2. The method of claim 1, wherein the problematic interaction is an interaction previously defined by the second account via the social networking system.

3. The method of claim 1, wherein the problematic interaction includes at least one of:
a direct message between the first account and a third account of the social networking system, wherein the first account is not associated with the third account; or
a direct message between the first account and the third account, wherein the third account has been previously reported on the social networking system.

4. The method of claim 1, wherein determining the interaction is a problematic interaction further comprises:
receiving, from the second account and via the social networking system, an indication of a period of time; and
determining the interaction between the first account and the content item is within the period of time.

5. The method of claim 1, wherein determining the interaction is a problematic interaction further comprises:
determining an age associated with a user associated with the first account and user associated with a third account associated with the content item;
determining a difference in the age of the user associated with the first account and the user associated with the third account; and
determining a threshold age difference;
wherein determining that the interaction is a problematic interaction is based at least in part on determining the difference in the age is greater than or equal to the threshold difference in age.

6. The method of claim 5, further comprising:
receiving, from the second account, an indication that a third account associated with the first account and the second account is an approved account, wherein the age of the user associated with the third account is greater than or equal to the threshold age difference;
receiving, from the first account, an indication of an interaction between the first account and the third account; and
refraining from sending a notification of the interaction between the first account and the third account to the second account.

7. The method of claim 1, wherein the one or more resources include one or more suggestions on how to discuss internet safety with a teenager.

8. The method of claim 1, wherein the second account is a supervisory account of the first account.

9. A system comprising:
one or more processors; and
computer-readable media storing instructions that, when executed by the one or more processors, cause the system to perform operations comprising:
receiving, from a first account of a social networking system, an indication of an interaction between the first account and a content item;
determining the interaction by the first account is a problematic interaction;
sending, based at least in part in determining the interaction is a problematic interaction and to a second account associated with the first account, a notification of the problematic interaction; and
causing presentation, to the second account, of a selectable control associated with one or more resources associated with addressing the problematic interaction with the first account.

10. The system of claim 9, wherein the problematic interaction is an interaction previously defined by the second account via the social networking system.

11. The system of claim 9, wherein the problematic interaction includes at least one of:
a direct message between the first account and a third account of the social networking system, wherein the first account is not associated with the third account; or
a direct message between the first account and the third account, wherein the third account has been previously reported on the social networking system.

12. The system of claim 9, wherein determining the interaction is a problematic interaction further comprises:
receiving, from the second account and via the social networking system, an indication of a period of time; and
determining the interaction between the first account and the content item is within the period of time.

13. The system of claim 9, wherein determining the interaction is a problematic interaction further comprises:
determining an age associated with a user associated with the first account and user associated with a third account associated with the content item;
determining a difference in the age of the user associated with the first account and the user associated with the third account; and
determining a threshold age difference;
wherein determining that the interaction is a problematic interaction is based at least in part on determining the difference in the age is greater than or equal to the threshold difference in age.

14. The system of claim 13, further comprising:
receiving, from the second account, an indication that a third account associated with the first account and the second account is an approved account, wherein the age of the user associated with the third account is greater than or equal to the threshold age difference;
receiving, from the first account, an indication of an interaction between the first account and the third account; and
refraining from sending a notification of the interaction between the first account and the third account to the second account.

15. One or more non-transitory computer-readable media storing instructions that, when executed by one or more processors of a server computing device, cause the server computing device to perform operations comprising:
receiving, from a first account of a social networking system, an indication of an interaction between the first account and a content item;
determining the interaction by the first account is a problematic interaction;
sending, based at least in part in determining the interaction is a problematic interaction and to a second account associated with the first account, a notification of the problematic interaction; and
causing presentation, to the second account, of a selectable control associated with one or more resources associated with addressing the problematic interaction with the first account.

16. The one or more non-transitory computer-readable media of claim 15, wherein the one or more resources include one or more suggestions on how to discuss internet safety with a teenager.

17. The one or more non-transitory computer-readable media of claim 15, wherein the second account is a supervisory account of the first account.

18. The one or more non-transitory computer-readable media of claim 15, wherein the problematic interaction is an interaction previously defined by the second account via the social networking system.

19. The one or more non-transitory computer-readable media of claim 15, wherein the problematic interaction includes at least one of:
a direct message between the first account and a third account of the social networking system, wherein the first account is not associated with the third account; or
a direct message between the first account and the third account, wherein the third account has been previously reported on the social networking system.

20. The one or more non-transitory computer-readable media of claim 15, wherein determining the interaction is a problematic interaction further comprises:
receiving, from the second account and via the social networking system, an indication of a period of time; and
determining the interaction between the first account and the content item is within the period of time.
